(19) United States
(12) Patent Application Publication
(10) Pub. No.: US 2009/0000965 A1
(43) Pub. Date: Jan. 1, 2009

(54) Holder for a Personal Identification Tag

(75) Inventor: Itai Arbel, Rosh Ha' Ayin (IL)

Correspondence Address: THE NATH LAW GROUP, 112 South West Street, Alexandria, VA, 22314, US

(73) Assignee: Lool Industrial Design Ltd, Kibbutz Nir Eliyahu (IL)

(21) Appl. No.: 12/087,364

(22) PCT Filed: Dec. 7, 2006
(86) PCT No.: PCT/IL2006/001405

§ 371 Date: Jul. 2, 2008

(30) Foreign Application Priority Data
Jan. 3, 2006 (IL) 172957

(51) Int. Cl. A45C 15/00

(52) U.S. Cl. 206/38

(57) ABSTRACT

A holder for a rigid personal identification tag is provided. The holder is adapted to retain the tag, and comprises at least one accessory integral therewith.

### FIELD OF THE INVENTION

This invention relates to holders for personal identification tags.

### BACKGROUND OF THE INVENTION

Many militaries and armed forces issue metallic personal identification tags, commonly called “dogtags” to their soldiers. These tags typically comprise basic information about the wearer, such as name and an identification number. Soldiers are expected to carry these tags on their body at all times, usually around their necks by a light rope, though preferably a metallic chain, e.g., a bead chain.

Since these tags are readily accessible to the wearer, soldiers commonly place other accessories either on the tag directly, or on the chain such that they are near the tag. Commonly, this accessory is a small flashlight or penknife.

### SUMMARY OF THE INVENTION

According to the present invention, there is provided a holder for a personal identification tag. The holder is adapted to retain the tag and comprises an accessory integral therewith.

The tag may be, for example, a dogtag which is often made of a rigid material, such as metal, so that it is adapted to endure harsh conditions, such as those undergone by a soldier during training and/or combat.

The accessory may be an electronic device, the holder comprising a power source therefor. The electronic device may be activated by a failsafe mechanism comprising two or more actuators to be simultaneously activated. Solar energy collectors adapted to charge the power source may be provided.

The electronic device may be a light source, such as a flashlight, a first light emitting diode (LED), or may emit a focused beam of light (commonly referred to as a laser pointer). A second LED may be provided, which may be activated independently of the first LED. The light source may be adapted to shine continuously or to flash intermittently.

The electronic device may be a global positioning system sensor or a radio. A sound output, such as a speaker or a socket adapted to receive therein a standard headphone jack, is provided in the case of a radio.

The electronic device may be a two-way communication device.

The holder may be adapted to receive data from an external memory source. Accordingly, it may comprise a screen to display information contained within the memory source. The tag itself or a data card may constitute the memory source. The data card may be of any format, such as a UICC smartcard running a subscriber identity module (commonly referred to as a SIM card).

The holder may be constructed such that at least the electronic device and the power source are disposed within a watertight housing. In addition, the holder may be fireproof. It will be appreciated that hereafter in the specification and claims, the term fireproof is to be understood in the broadest sense, including, but not limited to, fire resistant, fire retardant, flame retardant, and flame resistant.

The holder may be made from a non-reflective material.

The accessory may also be selected from the following: a blade, a screwdriver, a compass, a can opener, a bottle-cap opener, a scissors, a saw, a file, a corkscrew, a wire stripper, a reamer, pliers, a wire cutter, a wire stripper, a wire crimping tool, a gutting tool, and a whistle.

The accessory may be a feature adapted to retain a whistle or a pair of earphones, such as earbud-style earphones.

The holder may additionally be adapted to allow breaking of the tag therewithin and removal of at least one of the pieces. Alternatively, it maybe adapted to retain a second tag such that one of the tags may be removed while the other remains retained.

The holder may also comprise a through-going aperture. The aperture is disposed such that when the tag is retained, the through-going aperture and an aperture of the tag are coaxially aligned. Alternatively, the holder may comprise a link adapted to receive therethrough a cord. The cord may be, for example, a rope, a ball chain, or a link chain.

The holder may further comprise a cover adapted to conceal the tag, and it may be adapted to at least partially display the tag when retained therewithin.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a front perspective view of one embodiment of a holder according to the present invention;

FIG. 2 is a back perspective view of the holder illustrated in FIG. 1;

FIG. 3 is a back view of the holder illustrated in FIG. 1, with a tag inserted therein and disposed on a rope;

FIG. 4 is a back perspective view of a modification of the holder illustrated in FIG. 1;

FIG. 5 is perspective view of another embodiment of the holder according to the present invention; and

FIG. 6 illustrates a back perspective view of a further modification of the holder illustrated in FIG. 1.

### DETAILED DESCRIPTION OF EXEMPLARY EMBODIMENTS

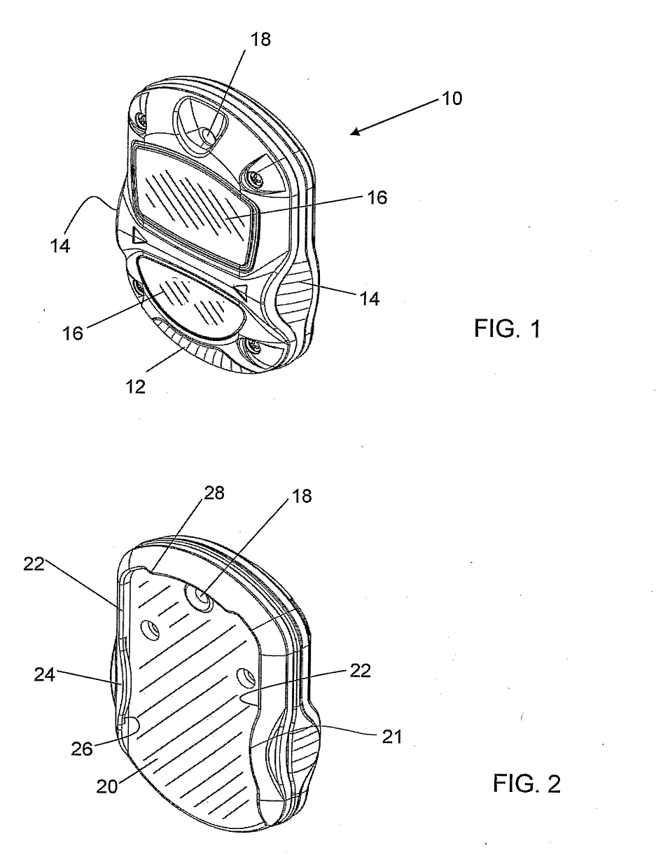

As illustrated in FIG. 1, there is provided a holder, generally indicated at 10, for a rigid military personal identification tag. The holder 10 comprises a light 12, which may be any suitable type of light source such as an incandescent bulb, LED, laser pointer, or the like, and two activating buttons 14. The holder further comprises a battery (not seen) adapted to supply power to the light 12. Solar panels 16, adapted to recharge the batteries, may be provided. The holder further comprises a through-going aperture 18.

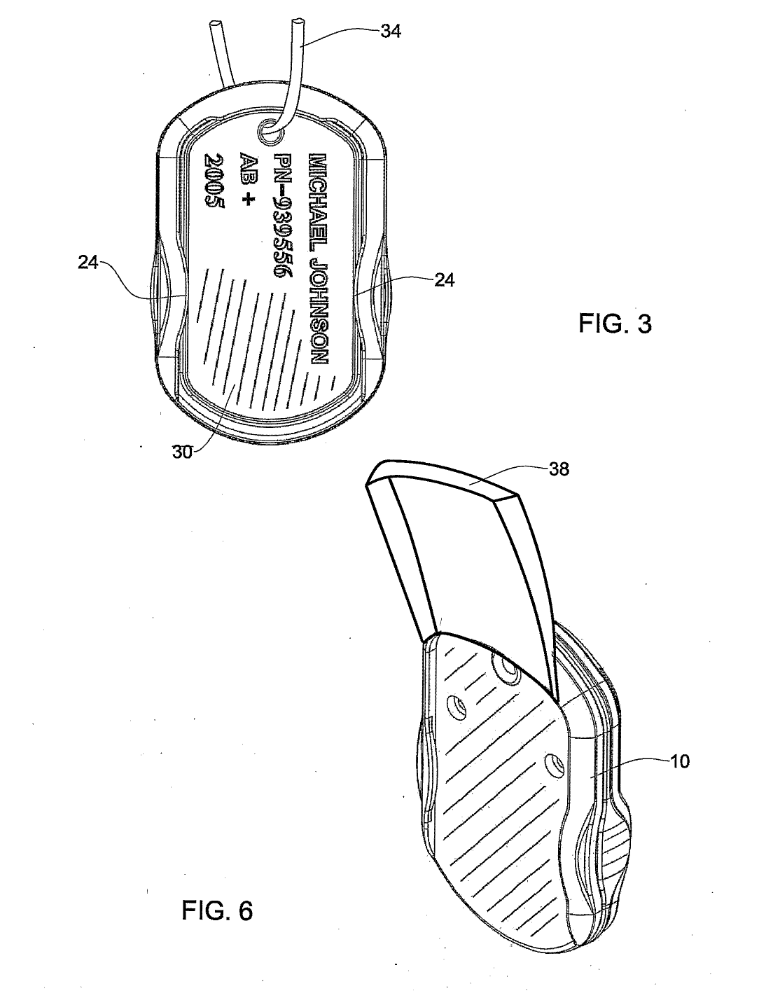

As illustrated in FIG. 2, the holder 10 further comprises a back panel 20, the width of which is bordered by vertical walls 22 extending from the holder. The distance between the walls 22 is substantially equal to the width of the tag. Extending from each vertical wall 22 is a grip 24 adapted to retain the tag. To that end, the grips 24 are separated by a gap 26 from the back panel 20. The gap 26 is equal to or slightly less than the exact thickness of the edge of the tag. The holder may further comprise a secondary grip 28, adapted to cover an additional edge of the tag. While not required, the secondary grip 28 allows for additional retention of the tag by the holder 10.

In use, as illustrated in FIG. 3, a tag 30 is inserted into the holder 10, such that is lays flat between the back panel 20 (not seen in FIG. 3) and the grips 24. One side of the tag 30 is thereby left exposed. When the tag 30 is fully inserted, the hole 32 thereof is aligned with the through-going aperture 18 of the holder, in order to permit introduction therethrough of a cord 34, such as one which permits wearing of the holder around the neck of a wearer. The cord 34 may be of any suitable construction, such as from light rope, a small bead chain, a link chain, etc.

In order to activate the light 12, both buttons 14 must be depressed. This feature is intended to prevent accidental illumination of the holder 10, which is especially important in situation when revealing the location of the wearer will compromise his security.

The light 12 may be a single light adapted, when activated, to shine continuously. Alternatively, there may be a number of lights (or LEDs, etc.), either of the same color or different colors. In particular, if lights of different colors are provided, a mechanism, such as a switch (not illustrated), additional buttons, or sequence of buttons may be employed in order to activate different lights. In addition, the light or lights may be adapted to be illuminated continuously or intermittently. If more than one option is provided, it may be selected in one of the same ways as listed above.

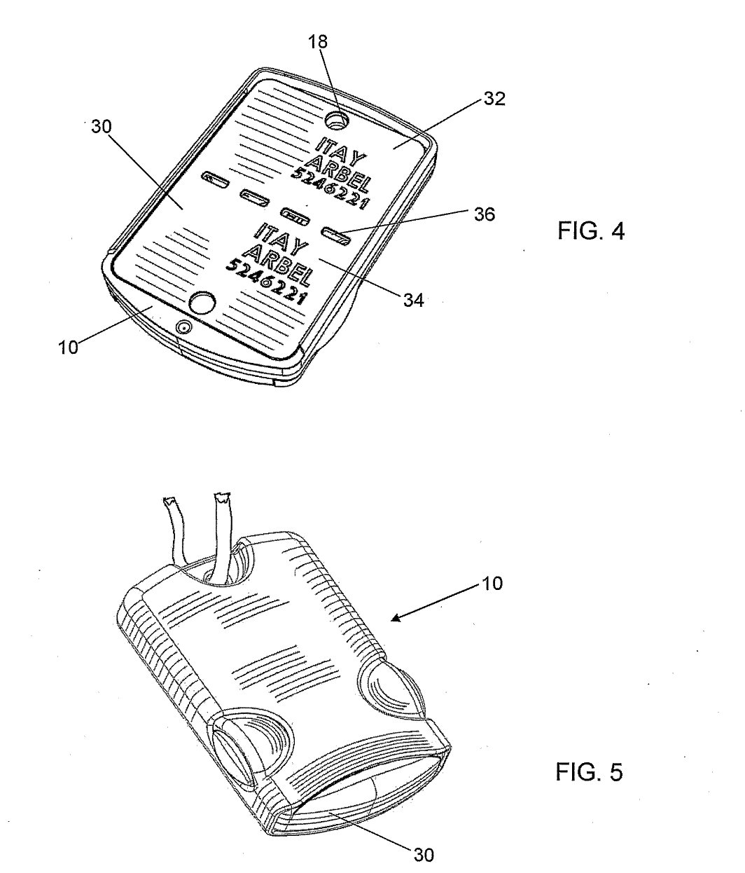

According to one modification of the above embodiment, as illustrated in FIG. 4, the holder 10 is adapted to accommodate a tag 30 which comprises a top half 32 and a bottom half 34 separated by a perforation 36. Such tag are used by some militaries so that in the event that a soldier is killed in battle and his body cannot be immediately evacuated, a comrade may break the tag in half, leaving one on the body for later identification thereof, and retaining one in order to inform others of the death. Therefore, the holder 10, according to the present modification, is adapted to grip the tag 30 such that it may be broken along the perforation 36, allowing the bottom half 34 to be removed while the top half 32 is retained within the holder 10. To that end, the grips 24 thereof are located on the half of the back panel which is closet to the through-going aperture 18.

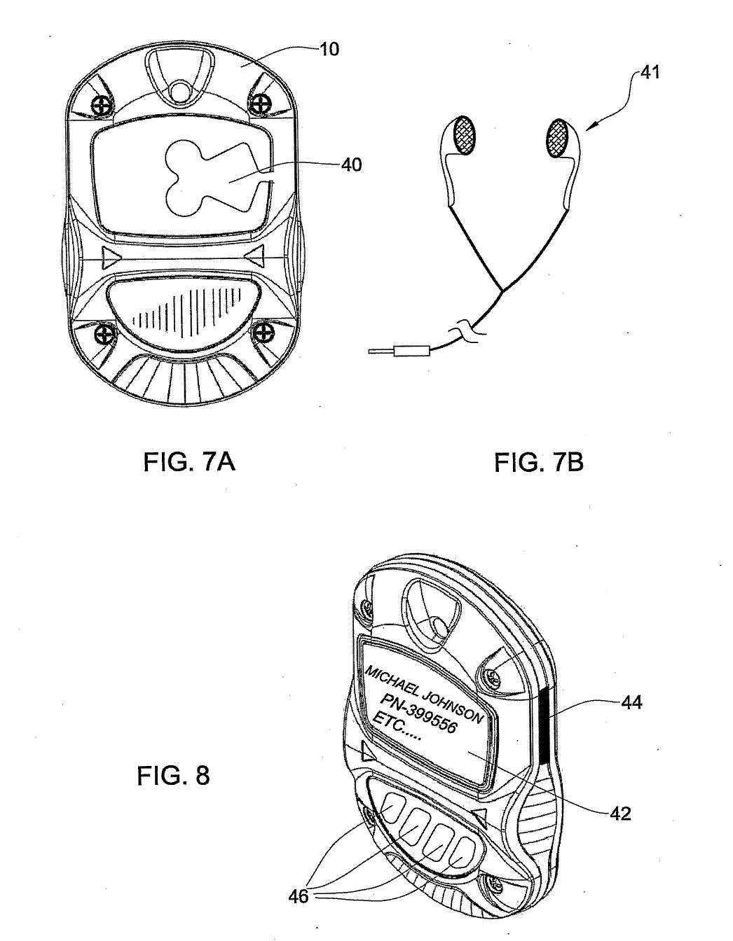

According to another embodiment, as illustrated in FIG. 5, the holder 10 is adapted to receive a tag 30 therewithin without having one side thereof exposed. This may be useful in situation wherein it is undesirable to have a shiny object such as a typical military identification tag in the open, in order to prevent it from reflecting incident light and giving away the position of the wearer. Alternatively, as illustrated in FIG. 6, a tag cover 38 may be provided to the embodiment illustrated in FIGS. 1 through 3. The tag cover may be solid, as illustrated, or may be made of a flexible material. Means may be provided to retain the tag cover 38 in the closed position, such as a spring (for a sold tag cover) or closing means, such as a hook and pile faster (such as Velcro™) or a snap (not illustrated).

According to any of the above embodiments, at least the outside of the holder 10 is made of a non-reflective material, in order to prevent it from reflecting incident light and giving away the position of the wearer. In addition, the holder may be fireproof, and it may also be waterproof, at least to the extent that components, such as the power source, which may be damaged by water, are protected.

The holder may comprise accessories, either in addition to or in lieu of, the light. For example, a global positioning system sensor may be provided, with a screen to indicate the position to the wearer. It may additionally be adapted to measure speed and/or distance covered.

The holder may also comprise a radio tuner, adapted to output sound either through an integral speaker or via a socket adapted to receive therein a standard headphone jack.

The holder may also comprise any accessory or accessories which is typically included in a multi-function tool, such as a blade, a screwdriver, a compass, a can opener, a bottle-cap opener, a scissors, a saw, a file, a corkscrew, a wire stripper, a reamer, pliers, a wire cutter, a wire stripper, a wire crimping tool, or a gutting tool. Alternatively, or in addition to another accessory, a whistle, or grips to hold an external whistle, may be formed within the holder.

As illustrated in FIG. 7A, the holder 10 may comprises a recess 40 formed therein, adapted to snuggly receive a pair of headphones, such as earbud style headphones 41, illustrated in FIG. 7B. A cover (not shown) may optionally be provided to cover the recess 40.

As illustrated in FIG. 8, the holder 10 may comprise a display 42 and a slot 44, adapted to receive a memory card (not shown), such as a SIM card. The card may contain personal data about the wearer, such as name, address, medical information (such as blood type and allergies) and history, and family contact information. The display 42 may be a touch-sensitive screen, or buttons 46 may be provided to control the display.

Those skilled in the art to which this invention pertains will readily appreciate that numerous changes, variations and modifications can be made without departing from the scope of the invention mutatis mutandis.

1. A holder for a personal identification tag, the holder adapted to retain said tag, and comprising at least one accessory integral therewith.

2. A holder according to claim 1, wherein the accessory is an electronic device and comprising a power source therefor.

3. A holder according to claim 2, wherein the electronic device is activated by a failsafe mechanism comprising two or more actuators to be simultaneously activated.

4. A holder according to claim 2, further comprising solar energy collectors adapted to charge the power source.

5. A holder according to any ne of claim 2, wherein the electronic device is a light source.

6. A holder according to claim 5, wherein the light source is selected from the group comprising a flashlight and a first light emitting diode (LED).

7. (canceled)

8. A holder according to claim 6, said light source being a first LED, further comprising a second LED.

9. A holder according to claim 8, wherein the second LED is activated independently of the first LED.

10. A holder according to claim 5, wherein the light source emits a focused beam of light.

11. A holder according to claim 5, wherein the light source is adapted to flash intermittently.

12. A holder according to claim 2, wherein the electronic device is a global positioning system sensor.

13. A holder according to claim 2, wherein the electronic device is a radio, the holder further comprising a sound output selected from the group comprising a speaker and a socket adapted to receive therein a headphone jack.

14. (canceled)

15. (canceled)

16. A holder according to claim 2, wherein the electronic device is a two-way communication device.

17. A holder according to claim 2, wherein at least the electronic device and power source are disposed within a watertight housing.

18. A holder according to claim 1, wherein the accessory is selected from the group comprising a blade, a screwdriver, a compass, a can opener, a bottle-cap opener, a scissors, a saw, a file, a corkscrew, a wire stripper, a reamer, pliers, a wire cutter, a wire stripper, a wire crimping tool, a gutting tool, and a whistle.

19. A holder according to claim 1, adapted to snuggly receive a whistle.

20. A holder according to claim 1, comprising a recess adapted to receive a pair of earphones.

21. A holder according to claim 20, wherein the earphone are earbud style earphones.

22. A holder according to claim 1, adapted to receive data from an external memory source.

23. A holder according to claim 22, further comprising a screen adapted to display information from the memory source.

24. A holder according to claim 22, wherein the identification tag constitutes the memory source.

25. A holder according to claim 22, wherein the memory source is a data card.

26. A holder according to claim 25, wherein the data card is a UICC smartcard running a subscriber identity module.

27. A holder according to claim 1, being made of a non-reflective material.

28. A holder according to claim 1, being fireproof.

29. A holder according to claim 1, allowing breaking of the tag into at least two pieces therewithin and removal therefrom of at least one of the pieces.

30. A holder according to claim 1, further adapted to retain a second tag such that one of the tags may be removed while the other remains retained.

31. A holder according to claim 1, comprising a through-going aperture disposed such that when the tag is retained, the through-going aperture and an aperture of the tag are coaxially aligned.

32. A holder according to claim 1, further comprising a cord.

33. A holder according to claim 1, further comprising a link adapted to receive therethrough a cord.

34. A holder according to claim 32, wherein said cord is selected from the group comprising a rope, a ball chain, and a link chain.

35. A holder according to claim 1, further comprising a cover adapted to conceal the tag.

36. A holder according to claim 1, wherein said tag is rigid.

37. A holder according to claim 1, adapted to at least partially display the tag when retained therewithin.
